(19) United States
(12) Patent Application Publication
(10) Pub. No.: US 2025/0116291 A1
(43) Pub. Date: Apr. 10, 2025

(54) BALL JOINT WHICH IS RESISTANT TO WEAR AND HIGH TEMPERATURES, AND METHOD FOR MANUFACTURING THE BALL JOINT

(71) Applicant: SKF Aerospace France S.A.S, Perrigny (FR)

(72) Inventors: Arnaud TURMEAU, Chabeuil (FR); Aiouba OMAR, Valence (FR); Louis BRIDONNEAU, Peyrins (FR)

(21) Appl. No.: 18/904,446

(22) Filed: Oct. 2, 2024

(30) Foreign Application Priority Data
Oct. 9, 2023 (FR) 2310766

(51) Int. Cl. F16C 11/06

(52) U.S. Cl. CPC F16C 11/0614; F16C 11/0604; F16C 11/0685; F16C 2204/52; F16C 2223/16

(57) ABSTRACT

A ball joint includes an outer ring having a spherical inner surface and an inner ring having a spherical outer surface in contact with the spherical inner surface of the outer ring. The outer ring is formed from a nickel-based material, the inner surface of the outer ring includes a carbonitrided layer, and the inner ring is formed from a cobalt-based or nickel-based material.

### CROSS-REFERENCE

This application claims priority to French patent application no. 2310766 filed on Oct. 9, 2023, the contents of which are fully incorporated herein by reference.

### TECHNOLOGICAL FIELD

The present disclosure is directed to the field of ball joints and, more particularly, to the compositions of the inner and outer rings of ball joints. More specifically, the disclosure is directed to the reduction of the wear of a ball joint by exploiting a particular composition of the outer ring of a ball joint and to a support system for supporting an engine on its housing, and to a method for manufacturing such a ball joint and such a support system.

### BACKGROUND

A support system may comprise conventional ball joints and/or shackles incorporating ball joints for supporting an engine in its housing. These components are generally made of a nickel or cobalt alloy, which materials are resistant to the high temperatures generated by combustion in a combustion chamber of the engine. The ball joints allow the support system to flex during thermal expansion of the engine.

A ball joint comprises an inner ring having an outer surface in contact with an inner surface of an outer ring. The synergy between the inner ring and the outer ring nevertheless has limited advantages in terms of high temperature, since there is wear of the materials of the rings over time. The outer ring of the ball joint may be a component added onto the support system and fastened by any suitable means, for example by a nut or by crimping, or may else be formed directly in the support system.

It is known to limit the wear of ball joints by forming the inner ring a cobalt alloy and forming the outer ring from a nickel alloy. This combination of materials allows good sliding behavior of one ring with respect to the other.

However, the wear still remains too high for this assembly and therefore necessitates regular, costly, maintenance of the engine support system.

### SUMMARY

An aspect of the disclosure is therefore to reduce wear caused by friction between the rings of a ball joint and thus increase the fatigue life of the components.

Another aspect of the disclosure is a ball joint comprising an outer ring having a spherical inner surface in contact with a spherical outer surface of an inner ring. The outer ring comprises a nickel-based material and a carbonitrided outer layer obtained by carbonitriding at least the inner surface of the outer ring. The inner ring comprises a cobalt-based or nickel-based material. With such a combination of materials, the wear caused by friction of the outer and inner rings of the ball joint is reduced.

Advantageously, the outer ring may have a carbonitrided outer surface radially opposite the inner surface obtained by carbonitriding at least the inner and outer surfaces. Advantageously, the outer ring may be made of a nickel-based alloy, in particular an alloy having the formula NiCr19Fe18Nb.

According to one embodiment, the inner ring is made of a cobalt-based alloy, in particular of a cobalt alloy of formula CoCr29W5. Alternatively, the inner ring may be made of a nickel-based alloy, in particular of a nickel alloy of formula NiCr19Fe18Nb that has a cobalt-based coating, the coating being positioned over all or part of the outer surface of the inner ring. Preferably, the inner ring is a solid-type ring made of cobalt alloy or nickel alloy. The term “solid-type ring” is understood to mean a ring whose shape is obtained by machining with material removal (turning, grinding) from tubes, bars or forged and/or rolled blanks.

Advantageously, the outer layer of the outer ring has a thickness of between 2 μm and 20 μm, preferably between 5 μm and 10 μm.

According to one embodiment, the inner ring has a bore radially opposite the spherical outer surface, and the ball joint comprises a sleeve which is mounted in the bore of the inner ring and has an outer surface radially in contact with the bore. The sleeve may comprise a nickel-based material, more particularly an alloy of formula NiCr19Fe18Nb.

Another aspect of the disclosure is a method for manufacturing a ball joint as defined above. The method comprises at least the following steps: providing an outer ring comprising a nickel-based material and an inner ring comprising a cobalt-based or nickel-based material, carbonitriding at least the inner surface of the outer ring, and assembling the outer ring with the inner ring.

Advantageously, the method may also include, before the step of assembling the outer ring with the inner ring, a step of treating the inner ring, the inner ring comprising an outer surface covered entirely or in part with a cobalt-based coating, preferably an alloy of formula CoCr29W5.

### BRIEF DESCRIPTION OF THE DRAWINGS

Other aspects of the disclosure will become apparent upon reading the following description, which is given purely by way of non-limiting example and with reference to the appended drawings, in which:

FIG. 1 illustrates a ball joint according to one exemplary embodiment of the invention.

FIG. 2 is a front view of the ball joint of FIG. 1.

FIG. 3 is a sectional view of the ball joint of FIG. 1.

FIG. 4 illustrates the steps of the method for manufacturing a ball joint according to one exemplary embodiment of the disclosure.

### DETAILED DESCRIPTION

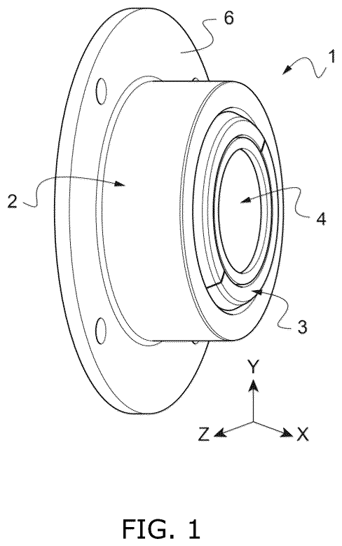

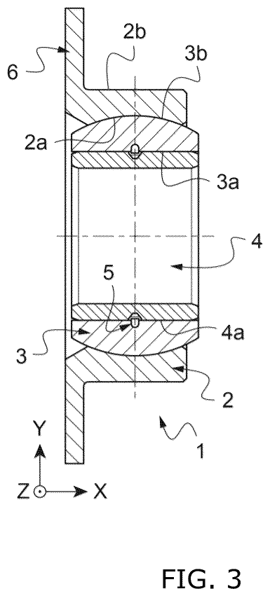

FIGS. 1, 2 and 3 illustrate a ball joint 1 according to an aspect of the disclosure in a reference frame (X, Y, Z). The ball joint includes an outer ring 2 and an inner ring 3 which are coaxial along an axis X.

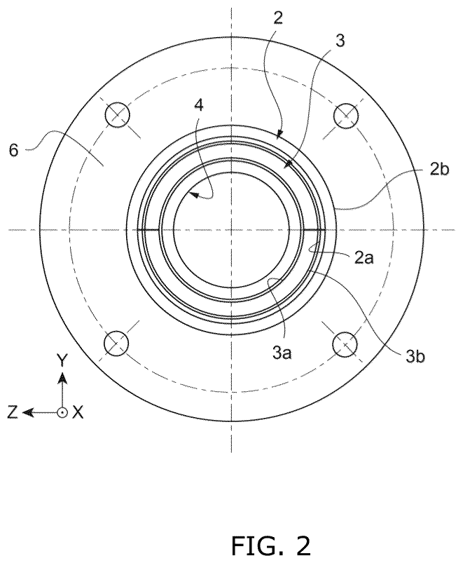

As illustrated in FIG. 2, the outer ring 2 has a concave spherical inner surface 2a or bore, an outer surface 2b radially opposite the inner surface 2a, and two opposite radial end faces (not referenced) axially delimiting the inner 2a and outer 2b surfaces.

The inner ring 3 has a convex spherical outer surface 3b on which the inner surface 2a of the outer ring 2 is mounted, a cylindrical bore 3a radially opposite the outer surface 3b, and two opposite radial end faces (not referenced) axially delimiting the bore 3a and the outer surface 3b. The inner surface 2a of the outer ring 2 and the outer 3b of the inner ring 3 are in contact with one another and have complementary shapes.

The outer ring 2 comprises a nickel-based material, particularly an alloy of the formula NiCr19Fe18Nb, and a carbonitrided outer layer obtained by carbonitriding at least the inner surface 2a of the outer ring This outer layer has a thickness of between 2 μm and 20 μm, preferably between 5 μm and 10 μm.

The outer surface 2b and the end faces of the outer ring 2 may also be treated by carbonitriding such that the outer ring 2 is entirely covered with the carbonitrided outer layer.

The inner ring 3 comprises a cobalt alloy of formula CoCr29W5, or a nickel alloy of formula NiCr19Fe18Nb and may in this case also have a cobalt-based coating, particularly of formula CoCr29W5. The coating covers all, or at least part, of the outer surface 3b of the inner ring 3.

Sliding between the inner surface 2a of the outer ring, which comprises a carbonitriding layer, and the inner ring 3, which comprises a cobalt-based or nickel-based alloy, causes very little wear.

In the exemplary embodiment illustrated, the ball joint 1 also comprises a sleeve 4 which is mounted in the bore 3a of the inner ring 3 and which forms the bore of the ball joint 1. The sleeve 4 has an annular shape and has an outer surface 4a radially in contact with the bore 3a of the inner ring 3.

In a manner known per se, the sleeve 4 and the inner ring 3 are assembled together by radial interposition of an elastic retaining ring 5 inside grooves formed on the outer surface 4a of the sleeve 4 and on the bore 3a of the inner ring 3. The sleeve 4 comprises a nickel-based material, more particularly an alloy of formula NiCr19Fe18Nb.

In another embodiment, the sleeve 4 could be omitted from the ball joint 1.

In the exemplary embodiment illustrated, the outer ring 2 of the ball joint 1 comprises a fastening flange 6 extending radially outwardly from one of the axial ends of the outer surface 2b. Alternatively, the flange 6 could be omitted from the outer ring 2 of the ball joint 1.

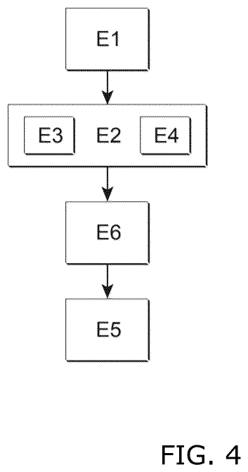

A method for manufacturing a ball joint 1 as described above is also provided. The method includes at least three steps illustrated by FIG. 4.

The method first of all comprises a step E1 of providing an outer ring 2 comprising a nickel-based material, and an inner ring 3 comprising a cobalt-based or nickel-based material. Next, the method comprises a step E2 of carbonitriding the inner surface 2a of the outer ring 2. It is also possible to envisage carbonitriding the outer surface 2b and the end faces of the outer ring 2 (that is, carbonitriding the entire outer surface of the outer ring).

This carbonitriding step E2 may, for example, comprise two substeps, a first case-hardening substep E3 and a second nitriding substep E4, which is carried out simultaneously or successively to the first substep E3 and in the same heat treatment cycle. A heat treatment cycle is characterized by raising the temperature from a low initial temperature to a high temperature, maintaining the high temperature, then lowering the temperature to a temperature close to the low initial temperature. For example, a heat treatment cycle corresponding to the step E2 of carbonitriding the inner surface 2a of the outer ring 2 starts with the first case-hardening substep E3, which uses acetylene to supply carbon, and continues with the second nitriding substep E4, which uses ammonia to supply nitrogen. The temperature of this heat treatment cycle may, for example, be between 400° C. and 500° C. and is maintained for the time necessary to achieve the desired carbon and nitrogen enrichment of the treated inner surface 2a. The carbonitriding step E2 ends with a rapid lowering of the temperature of the outer ring 2. The treated outer ring 2 is, for example, brought back down to ambient temperature. The carbonitriding treatment may last from 10 to 50 hours depending on the chosen thickness.

Finally, the method comprises a step E5 of assembling the inner 3 and outer 2 rings together.

Optionally, the method for manufacturing the ball joint 1 may further comprise a step E6 of treating the inner ring 3. During this step, the outer surface 3b of the inner ring 3 may be covered entirely, or only in part, with a cobalt-based coating, preferably an alloy of formula CoCr29W5.

The present invention has been illustrated on the basis of a ball joint comprising an inner ring and an outer ring which is intended to be added onto an associated support system. It would not be a departure from the scope of the invention if the outer ring of the ball joint were constituted directly by a component of the support system by machining to form the inner surface of the outer ring.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved ball joints.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A ball joint comprising:
an outer ring having a spherical inner surface, and
an inner ring having a spherical outer surface in contact with the spherical inner surface of the outer ring,
wherein the outer ring comprises a nickel-based material,
wherein the inner surface of the outer ring includes a carbonitrided layer, and
wherein the inner ring comprises a cobalt-based or nickel-based material.

2. The ball joint according to claim 1,
wherein the outer ring includes a carbonitrided outer surface radially opposite the inner surface.

3. The ball joint according to claim 1,
wherein the outer ring comprises an alloy of formula NiCr19Fe18Nb.

4. The ball joint according to any claim 3,
wherein the inner ring comprises an alloy of formula CoCr29W5.

5. The ball joint according to claim 3,
wherein the inner ring comprises a nickel alloy of formula NiCr19Fe18Nb and
wherein at least part of the outer surface of the inner ring includes a cobalt-based coating.

6. Ball joint according to claim 1,
wherein the carbonitrided layer of the outer ring has a thickness of 2 μm to 20 μm.

7. Ball joint according to claim 1,
wherein the carbonitrided layer of the outer ring has a thickness of 5 μm to 10 μm.

8. A ball joint according to claim 7,
wherein the inner ring has a bore radially opposite the spherical outer surface, and
wherein the ball joint further comprises a sleeve mounted in the bore with an outer surface of the sleeve in radial contact with an inner surface of the bore.

9. A ball joint according to claim 8,
wherein the sleeve comprises an alloy of formula NiCr19Fe18Nb.

10. A method for manufacturing a ball joint comprising:
providing an outer ring comprising a nickel-based material and a spherical inner surface,
providing an inner ring comprising a cobalt-based or nickel-based material and having a spherical outer surface,
carbonitriding at least the spherical inner surface of the outer ring, and
assembling the outer ring with the inner ring.

11. The method according to claim 10, further comprising, before assembling the outer ring with the inner ring, treating the inner ring to produce a cobalt-based coating on the spherical outer surface of the inner ring.

12. The method according to claim 11,
wherein the cobalt-based coating comprises an alloy of formula CoCr29W5.

13. The ball joint according to claim 12,
wherein the outer ring comprises an alloy of formula NiCr19Fe18Nb.

14. The ball joint according to any claim 1,
wherein the inner ring comprises an alloy of formula CoCr29W5.
